(19) United States
(12) Patent Application Publication
(10) Pub. No.: US 2004/0145486 A1
(43) Pub. Date: Jul. 29, 2004

(54) Utility power line cable selector system

(76) Inventors: George Campbell, Aurora, CO (US); Eugene Campbell, Denver, CO (US)

Correspondence Address: Edwin H. Crabtree, Suite 575, 3773 Cherry Creek N. Dr., Denver, CO, 80209, US

(21) Appl. No.: 10/353,920

(22) Filed: Jan. 28, 2003

(51) Int. Cl. G08B 21/00

(52) U.S. Cl. 340/635; 324/527; 324/66

(57) ABSTRACT

A utility power line cable selector system used by a lineman to eliminate guessing which buried cable in a ditch has been de-energized when compared to similar buried cables that are still energized with high voltage 60 Hz. power line current and disposed next to the de-energized cable. The selector system includes a battery operated low power 1 Hz. pulse generator adapted for connecting to a near end of a de-energized cable. The generator is designed to deliver a dc current spike and excite the otherwise de-energized conductor at one second intervals. At a far end of the de-energized cable is connected to a jumper cable. At a location midspan or between the near end and far end of the de-energized cable, the lineman holds a portable hand-held signal pick up clamp and cable detector unit. The signal pick up clamp is placed around a portion of each of the cables in the ditch. The cable detector unit includes an electronic filter, a pulse amplifier and a monstable multivibrator with audio and visual indicators to detect if the cable under test has the dc current spike or the test signal flowing through it's conductor. The filter is designed to prevent a response from 60 Hz. power line current in the energized cables and responds only to the conductor connected to the output from the pulse generator.

### BACKGROUND OF THE INVENTION

(a) Field of the Invention

This invention relates to a power line current test system and more particularly, but not by way of limitation, to a portable utility power line cable selector system for indicating to a power line construction lineman or maintenance crew lineman which buried cable among many buried cables in a ditch has been de-energized. The de-energized buried cable selected for repair work, splicing and/or adding an additional power line or lines thereto.

(b) Discussion of Prior Art

Heretofore, power line construction lineman and maintenance utility power lineman have complained for years on why hasn't a reliable power line cable selector system been developed which can be used with confidence for determining which buried power line cable has been de-energized for working thereon when compared to other energized power line cables.

Currently, construction and maintenance lineman use an approximate eight foot long insulated pole for turning a threaded spike mounted on a “C” clamp attached to a selected cable. As the spike is rotated on the clamp using the insulated pole, a tip of the spike pierces through the cable's outside insulation cover, through insulation inside the cover and engages an electric conductor surrounded by the insulation. Hopefully, the conductor has been de-energized and without power. On the other hand, if the crew guesses wrong, the selected cable blows up and the crew is placed in danger, even at the end of the insulated pole. Also, power to electric customers is disrupted for an extended period of time until the cable can be repaired.

An obvious answer to the proper selection of a de-energized buried cable is to color code each of the buried cables disposed next to each other. But, because of added cost of coloring the outside insulation cover and the added cost of having to inventory large numbers of different colored power line cables, utility companies have opted not to color code power line distribution cables. Therefore, the problem of guessing the correct de-energized cable among many other energized cables in the field remains. Obviously, this problem presents a great safety hazard to lineman and utility companies.

Tone signal and multiple frequency test equipment can be used for proper cable selection. But, this type of test equipment requires de-energizing all of the buried cables, which can be any number of cables disposed side by side. The de-energizing of all of the buried cables is rarely done since it requires turning off power for an extended period of time to all of the utility power company's customers being served by the power distributed through the buried cables.

In U.S. Pat. Nos. 3,924,179 to Dozier and 3,882,287 to Simmonds, methods of certifying dead cables or conductors and detecting faults in multi-conductor cables are disclosed. In U.S. Pat. No. 2,789,268 to Bechtel et al., a method and apparatus is described for identifying electric conductors. In U.S. Pat. No. 5,471,143 to Doany, an apparatus for locating buried conductors is illustrated. In U.S. Pat. No. 4,491,785 to Pecukonis, a signal detection device is disclosed using high frequency loading. The loading is used for tracing and identifying electrical conductors. In U.S. Pat. No. 5,760,591 to Matsuda et al., a method and apparatus for determining an electrical wiring state is described.

None of the above mentioned prior art patents specifically disclose the unique safety features, structure and function of the subject power line midspan cable selector system for correctly identifying a buried de-energized power line cable disposed in a ditch and next to a plurality of energized power line cables carrying high voltage 60 Hz. power line current.

### SUMMARY OF THE INVENTION

In view of the foregoing, it is a primary objective of the subject invention to eliminate guessing by a lineman on which buried cable in a ditch has been de-energized when compared to similar buried cables that are still energized with high voltage 60 Hz. power line current and disposed next to the de-energized cable.

Another object of the subject invention is to eliminate the blowing up of a power line cable in a ditch using a long insulated pole with “C” clamp and spike, since the correct de-energized cable can now be correctly selected among the other energized cables.

Yet another object of the invention is the power line cable selector system solves the problem of personal safety to lineman who have to try and select a de-energized power line cable from other energized cables. Obviously, with increased safety to lineman, liability risks to a utility company are reduced.

The power line cable selector system includes a battery operated low power 1 Hz. current pulse generator adapted for connecting to a near end of a de-energized cable at an upstream disconnect station. The generator is connected to one end of the cable's insulated conductor and connected to a first ground line. The first ground line is connected to the common neutrals of the de-energized cable and the other energized cables. The generator is designed to deliver a de current spike and excite the otherwise de-energized conductor at one second intervals. Obviously, the generator can be designed to deliver different phase current as long as it is not the same as the 60 Hz. power line current flowing through the other buried energized power line cables.

At a far end of the de-energized cable and at a downstream disconnect station, the selector system includes a jumper cable. The jumper cable is attached to the far end of the insulated conductor and a second ground line connected to common neutrals of the de-energized cable and the other energized cables. The jumper cable connection provides a round trip path from the generator output, through the insulated conductor and a return path via the grounded common neutrals. The length of the de-energized cable and the other cables between the upstream and downstream disconnect stations may be less than 100 feet and up to several miles. The testing to determine which cable is de-energized will always be at a location midspan or somewhere between the two disconnect stations. The disconnect stations may be power line cable switching stations and the like. During the testing for the disconnected or de-energized cable, the other cables may remain energized and they do not interfere with the use of the cable selector system.

Further, the cable selector system includes a portable hand-held pulse sensing receiver and cable detector unit with a signal pick up clamp. The detector unit and pick up clamp are used between the two disconnect stations and in a ditch where the de-energized cable is to be detected. The signal pick up clamp is placed around a portion of each of the cables in the ditch. The pulse sensing receiver and detector unit includes an electronic parametric filter, a pulse amplifier and a monstable multivibrator with audio and visual indicators to detect if the cable under test has the dc current spike or the test signal flowing through it's conductor. The audio indicator includes a horn and the visual indicator includes a blinking LED and a current analog meter. The parametric filter is designed to prevent a response from the 60 Hz. power line current in the energized cables and respond only to the conductor connected to the output from the pulse generator. The detector housing unit with signal pick up clamp allows the lineman to check each cable in the trench and determine which cable is de-energized and has the generated test signal running through it's conductor.

These and other objects of the present invention will become apparent to those familiar with various power line test systems used with utility power lines when reviewing the following-detailed description, showing novel construction, combination, and elements as herein described, and more particularly defined by the claims, it being understood that changes in the embodiments to the herein disclosed invention are meant to be included as coming within the scope of the claims, except insofar as they may be precluded by the prior art.

### BRIEF DESCRIPTION OF THE DRAWINGS

The accompanying drawings illustrate complete preferred embodiments in the present invention according to the best modes presently devised for the practical application of the principles thereof, and in which:

FIG. 1 is a perspective view of a power line construction lineman or maintenance lineman shown in a ditch and using the portable hand-held cable detector unit with signal pick up clamp. The lineman is shown checking one of the buried cables to determine if it is a de-energized cable.

FIG. 2 is a cross section of a typical high voltage power line cable.

FIG. 3 is a schematic drawing of three power line cables. One of the cables is shown as an isolated and de-energized cable for performing repair work thereon and/or splicing additional cables thereto. The other two cables remain energized.

FIG. 4 is a general electrical diagram of the current pulse generator attached to a near end of the de-energized cable and generating a low voltage dc current spike and used as a test signal.

FIG. 5 is a general electrical diagram of the pulse sensing and cable detector unit with signal pick up clamp. The pick up clamp is used for receipt around a portion of each power line cable in the ditch.

FIG. 6 is a detailed electrical diagram illustrating all of the individual electrical components connected together and making up the current pulse generator.

FIG. 6A a test signal sent from the pulse generator and received by the pulse sensing and cable detector unit.

FIG. 7 is a detailed electrical diagram illustrating all of the individual electrical components connected together and making up the pulse sensing receiver and cable detector unit with the signal pick up clamp.

FIG. 8 is a detailed electrical diagram of an alternate embodiment of the pulse signal filter as a high pass filter. The high pass filter can be used as part of the cable detector unit.

FIG. 9 illustrates the response of the two filter configurations described and illustrated in FIGS. 7 and 8.

### DETAILED DESCRIPTION OF THE PREFERRED EMBODIMENTS

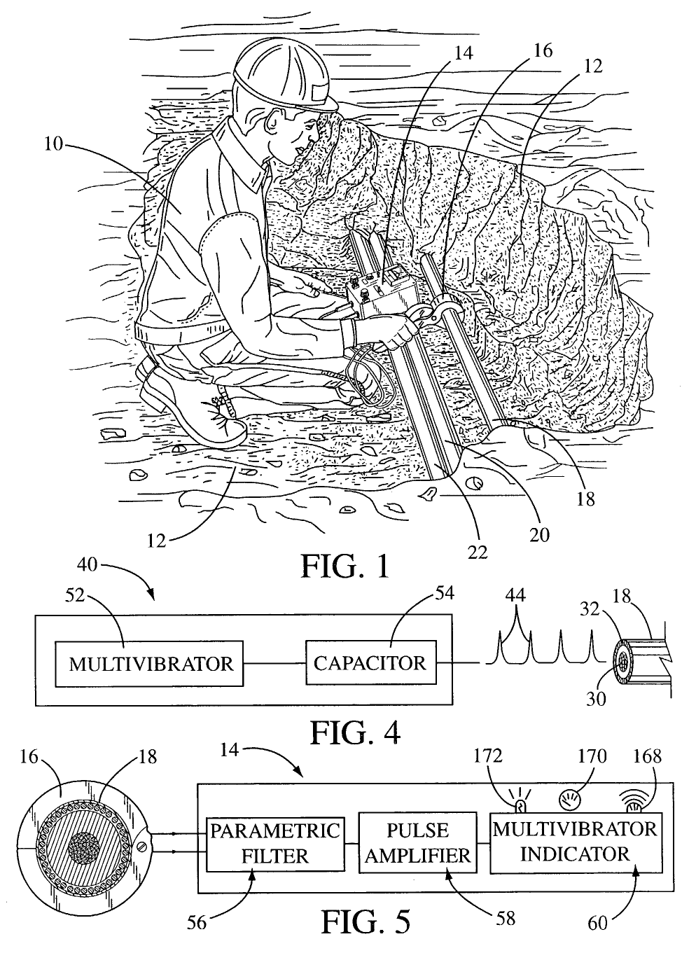

In FIG. 1, a perspective view of a power line construction lineman or maintenance lineman 10 shown in a ditch 12 and using the portable hand-held pulse sensing receiver and cable detector unit. The detector unit has a general reference numeral 14. The detector unit 14 includes a signal pick up clamp 16 used for receipt around a portion of a first buried cable 18 to determine if it is a de-energized cable. The buried cable 18 is disposed next to a second buried cable 20 and a third buried cable 22.

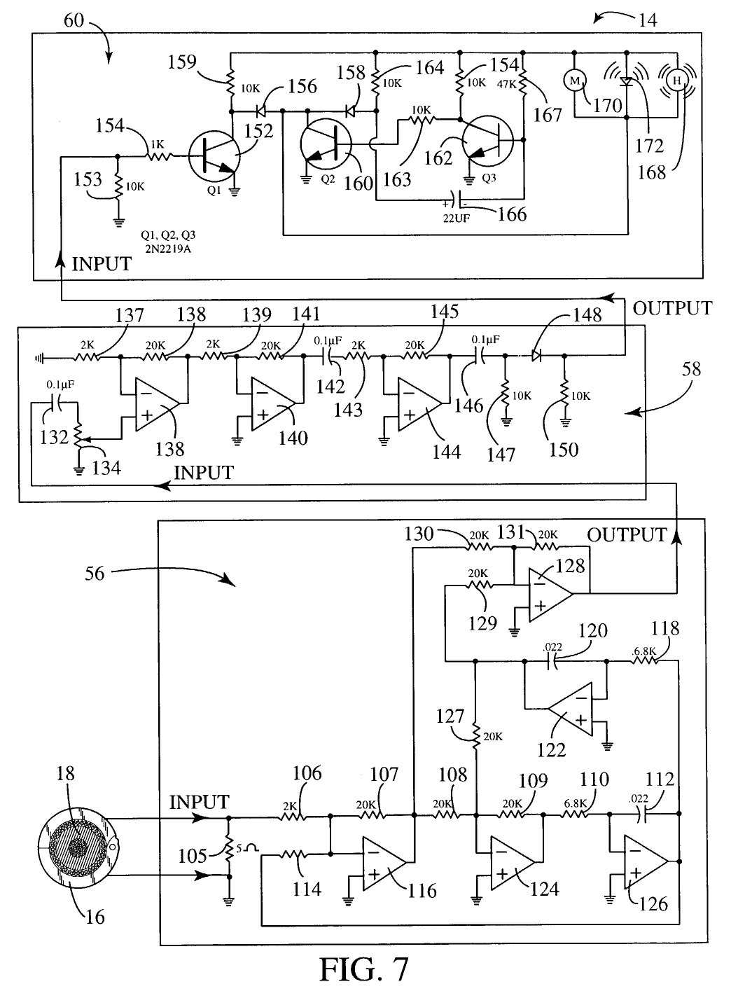

The ditch 12 can include any number of buried cables that need to be tested to determine the de-energized cable. The detector unit 14 with the signal pick up clamp 16 are one part of the overall cable selector system and are described in greater detail in FIGS. 5 and 7.

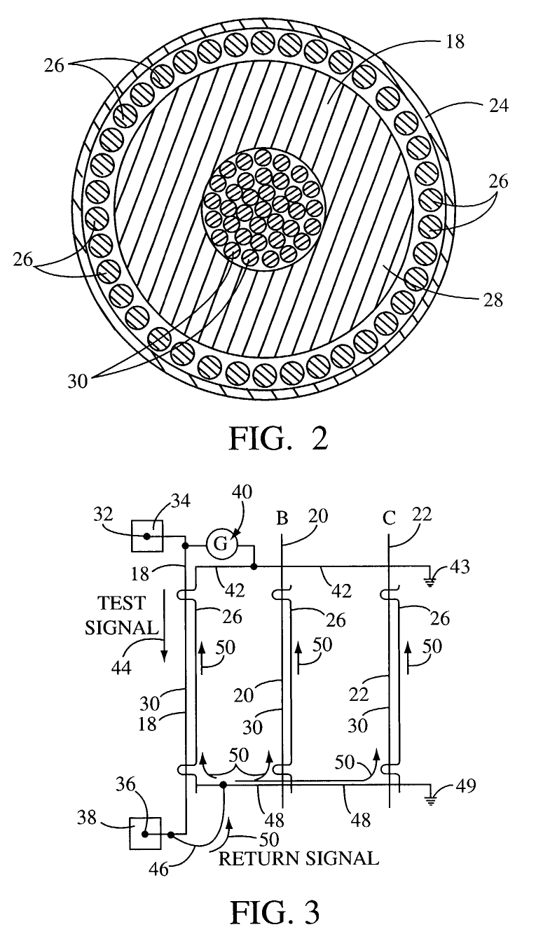

In FIG. 2, a cross section of the high voltage power line cable 18 is illustrated. The cable 18 includes an outer insulation cover 24, concentric neutrals 26 and inside insulation 28 surrounding a stranded high voltage conductor 30, which typically in the United States distributes 60 Hz. power line current.

In FIG. 3, a schematic drawing of the three power line cables 18, 20 and 22 are shown. In this example, cable 18 has been isolated and de-energized for performing repair work thereon or splicing additional cables thereto. At a near end 32 of the cable 18, the cable has been disconnected at an upstream disconnect station, shown as square 34. Also, at a far end 36 of the cable 18, the cable has been disconnected at a downstream disconnect station, shown as a square 38. As mentioned above, the distance between the two disconnect stations 34 and 38 or the length of the disconnected cable 18 may vary from less than 100 feet and up to several miles.

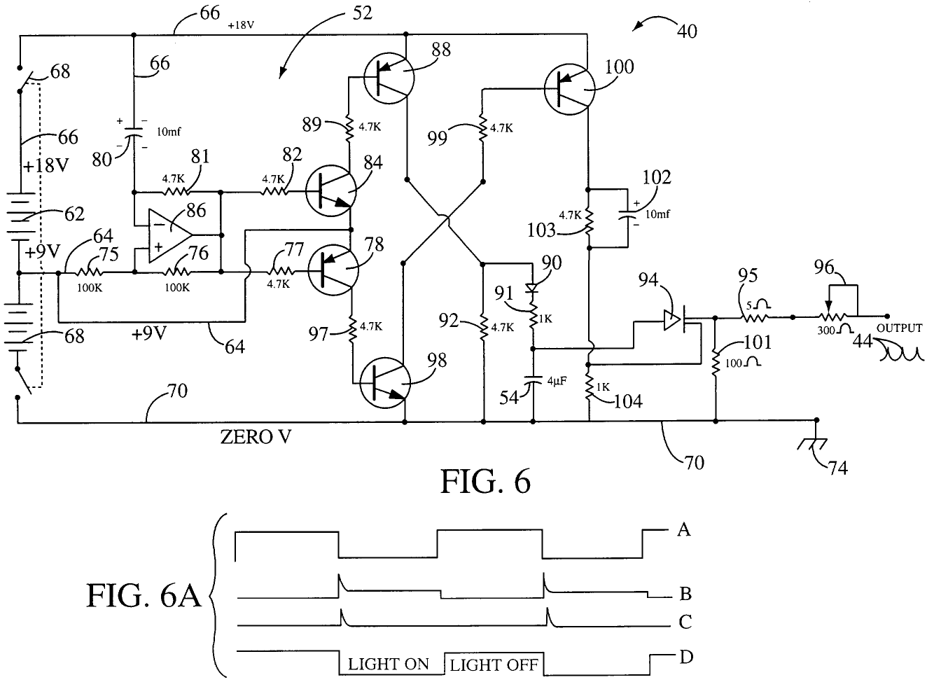

A battery operated, low power current pulse generator, having a general reference numeral 40, is connected at the near end 32 to the conductor 30 of the cable 18. Also, the generator 40 is connected to a first ground line 42. The first ground line 42 is connected to each of the neutrals 26 in the cables 18, 20 and 22 and a ground 43. The pulse generator 40 is another part of the cable selector system and is described in greater detail in FIGS. 4 and 6. The generator 40 provides a low power current test signal with a 1 Hz repetition rate, shown as arrow 44.

A jumper cable 46 is shown connected at the far end 36 to the conductor 30 of the cable 18. The jumper cable 46 is also shown connected to a second ground line 48. The second ground line 48 is connected to each of the neutrals 26 in the cables 18, 20 and 22 at the downstream disconnect station 38 and to a ground 49. The jumper cable 46 is another part of the cable selector system.

The jumper cable connection provides a round trip path from the generator's test signal 44, through the insulated conductor 30 of the cable 18 and a return signal, shown as arrows 50, via the grounded common neutrals 26 connected to the ground lines 42 and 48. As mentioned above, the testing to determine which cable is de-energized will always be at a location midspan or somewhere between the two disconnect stations 34 and 38. The disconnect stations 34 and 38 may be power line cable switching stations and the like. During the testing for the disconnected or de-energized cable 18, the other cables 20 and 22 may remain energized and they do not interfere with the use of the cable selector system.

FIG. 4 is a general electrical diagram of the current pulse generator 40. It is shown attached to the near end 32 of the de-energized cable 18. The pulse generator 40 is illustrated broadly including a battery powered free running multivibrator 52 for charging and discharging a capacitor 54. The multivibrator 52 combined with the capacitor 54 make up a 1 Hz pulse generator. The electrical components of the multivibrator 52 connected to the capacitor 54 are shown in detail in FIG. 6 and making up the pulse generator 40 for creating the low voltage test signal 44.

In FIG. 5, a general electrical diagram of the cable detector unit 14 and signal pick up clamp 16 is shown. The key components making up the detector unit 14 include a parametric filter, having general reference numeral 56, a pulse amplifier, having general reference numeral 58 and a monostable multivibrator indicator, having general reference numeral 60. The electrical components making up the filter 56, the amplifier 58 and the indicator 60 are shown in detail in FIG. 7.

In FIG. 6, a detailed electrical diagram illustrating the individual electrical components of the free running multivibrator 52 making up the current pulse generator 40 are shown. The electrical components include a pair of 9 volt batteries 62 connected to a 9 volt line 64, an 18-volt line 66 with a switch double throw 68 and a zero volt line 70 via the other half of the switch 68. The other half of the switch 68 is connected to ground 74. Resistor 77 is connected to a transistor 78 and resistor 82 is connected to a transistor 84.

An operational amplifier 86 is connected to the 18-volt line 66 by a capacitor 80 and with a resistor 81, a resistor 75 and a resistor 76 comprise a free running multivibrator. A transistor 88 is connected to the 18-volt line 66 and the transistor 84 is connected via a resistor 89 to a transistor 88. The transistor 88 is connected to the capacitor 54 via a diode 90 and resistor 91, The capacitor 54 is connected to the zero volt ground line 70. The transistor 88 is also connected to the zero volt line 70 via resistor 92. The capacitor 54 is also connected to a SCR 94, a resistor 95 and an adjustable resistor 96 prior to outputting the test signal 44.

The output of the multivibrator 52 is illustrated as a square waveform “A”, shown in FIG. 6A. When waveform “A” is positive, transistor 84 is turned “on”, which activates transistor 88. When transistor 88 is turned “on”, capacitor 54 is charged. The actual current pulse delivered to the conductor 30 is the discharge current of the capacitor 54 initiated at the time of the negative transition of the 1 Hz waveform “A”.

A current pulse waveform “C”, shown in FIG. 6A, or test signal 44 coincides with a gate pulse waveform “B” as shown in FIG. 6A and from the SCR 94. When waveform A, shown in FIG. 6A, swings negative, resistor 77 switches the transistor 78 “on” and turning transistor 98 “on”. Resistor 99 in turn switches transistor 100 “on”. The transistor 100 then turns the SCR 94 “on”, which discharges the capacitor 54. The SCR 94 stays “on” until the capacitor 54 is discharged. The peak current is limited by the resistor 95. A resistor 101, connected to the zero volt line 70, inhibits ringing in the conductor 30 of the cable 18. It should be mentioned that any significant ringing anywhere in the cable detector unit 14 can cause a false signal indication. A capacitor 102 by passes a resistor 103 for allowing a larger initial turn on pulse to the SCR 94. The capacitor 102 is connected to the zero volt line 70 via a resistor 104. Resistor 104 develops the waveform “B”, shown in FIG. 6A, which turns on the SCR 94.

In FIG. 7, a detailed electrical diagram is shown illustrating all of the individual electrical components making up the cable detector unit 14 connected to the signal pick up clamp 16. The clamp 16 is a current transformer similar to those used with clamps for current meters. The size of the clamp is determined by the diameter of the cables being tested.

The clamp 16 is connected to the parametric filter 56. The filter 56 is designed to reject a signal developed across the resistor 105 resulting from any 60 Hz current from the energized cables, while the filter passes the high frequency components of the 1 Hz test signal 44. The clamp 16 will respond to the magnetic field that accompanies any current flowing through the conductor 30.

The output of the clamp 16 is connected to a resistor 105, which develops an input signal voltage processed first by the filter 56. The output of the clamp 16 is also connected to resistors 106, 107, 108, 109, 110 and capacitor 112. Between the resistors 106 and 107 are connected a resistor 114 and an amplifier 116. The resistor 114 is connected to a resistor 118, a capacitor 120 and an amplifier 122. Between the resistors 108 and 109 and resistors 109 and 110 is connected an amplifier 124. Between the resistor 110 and the capacitor 112 and the resistor 114 is connected an amplifier 126. The amplifier 124 is connected to the input of an amplifier 128 via resistors 127 and 129. The amplifier 116 is also connected to the input and output of amplifier 128 via resistors 130 and 131.

The parametric filter 56 exhibits two feedback loops. Both loops stabilize the dc voltage at the output of the operational amplifier 126 at zero volts. At the 60 Hz frequency, the signal at the output of operational amplifiers 116 and 122 is equal in amplitude and 180 degrees out of phase. These two signals delivered to the summing amplifier 128 result in zero output voltage at the 60 Hz frequency, while the test signal 44 is passed on to input the pulse amplifier 58.

The pulse amplifier 58 comprises an input capacitor 132 and a gain control pot 134 connected to a non-inverting operational amplifier 136. The amplifier 136 is connected between resistors 137 and 138 and between resistors 138 and 139. An inverting amplifier 140 is connected between resistors 139 and 141 and resistor 141 and a capacitor 142. The capacitor 142 is connected between the resistor 141 and a resistor 143. Another inverting amplifier 144 is connected between resistor 143 and a resistor 145. The amplifier 144 is connected between the resistor 145 and a capacitor 146. The output of the capacitor 146 is connected to a resistor 147, a diode 148 and resistor 150.

The input capacitor 132 and the capacitors 142 and 146 between the inverting amplifiers 140 and 142 block any dc offset that would accumulate if the amplifiers were directly coupled. The overall maximum gain of the amplifiers 136, 140 and 144 is 1000 determined by the resistors 137, 138, 139, 141, 143 and 145. The arrangement of the non-inverting amplifier and the inverting amplifiers are such that a positive signal pulse voltage at the input to the resistor 105 of the filter 56 coincides with a positive pulse voltage at the output of the operational amplifier 144 of the pulse amplifier 58.

The pulse output of the amplifier 58 is delivered to an input of the multivibrator indicator 60. The purpose of the “one shot” multivibrator is to stretch a very narrow 1 Hz pulse signal into a 1 Hz rectangular wave, as illustrated as waveform “D” and shown in FIG. 6A. The waveform “D” is delivered to provide an output indication, which is easy to recognize and without confusion relative to any possible false signal received through the cable's conductor 30.

The input to the indicator 60 is received by a transistor 152 via resistors 153 and 154, which momentarily turns the transistor 152 “on”. The transistor 152 is connected to diodes 156 and 158 and resistor 159. A transistor 160 is connected between the diodes 156 and 158 and connected to a transistor 162 via a resistor 163. A negative transition of the collector of the transistor 152 is passed via the diodes 156 and 158 to a resistor 154 and via a charged capacitor 166 to the transistor 162. During a steady state and while waiting for a pulse signal, the resistor 154 keeps transistor 162 “on”. This keeps the collector voltage of the transistor 162 low and transistor 160 “off”. An incoming pulse signal turns transistor 152 “on” via the resistor 154. The “on” state of transistor 152 drives its collector low, which via diodes 156 and 158 holds the resistor 164 low. Transistor 160 stays “on” until capacitor 166 discharges and returns to a steady state with the transistor 162 “on” and the transistor 152 “off”. The “one shot” then waits for the next pulse signal. The values of capacitor 166 and resistor 167 are selected to keep transistor 160 “on” for approximately ½ second. This feature allows a horn 168 to beep, an analog meter 170 to respond and register and an LED 172 to light up for providing the lineman 10 both visual and audio indicators that the cable 18 is de-energized and the cable detection unit 14 is receiving the test signal 44.

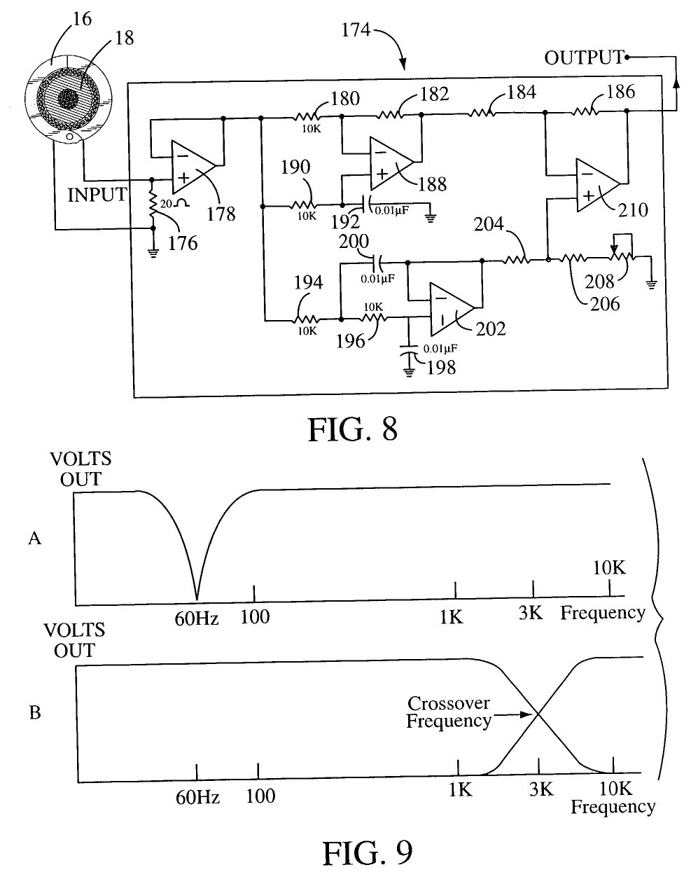

In FIG. 8, a second embodiment of the cable detector unit's filter is described as a high pass filter having a general reference numeral 174. The high pass filter 174 is used in place of the parametric filter 56. A graph of the output voltage versus log frequency of the filter 174 is illustrated as waveform B shown in FIG. 9.

The input from the clamp 16 is connected to a resistor 176 and an amplifier 178. The output of the amplifier 178 is connected to resistors 180, 182, 184 and 186. An amplifier 188 is connected between the two resistors 180 and 182 and between a resistor 190 and a capacitor 192. The output of the amplifier 178 is also connected to resistor 194 and a capacitor 198. The capacitor 198 is connected between the resistor 194 and to an amplifier 202. The output of the amplifier 202 is connected to resistors 204, 206 and adjustable resistor 208. An amplifier 210 is connected between the resistors 204 and 206 and between resistors 184 and 186.

The output circuit of the high pass filter 174 or the amplifier 210 is a balanced differential amplifier. This type of amplifier inherently rejects common mode signals. Common mode signals are identical in amplitude shape and relative phase at the inverting and non-inverting inputs. The effectiveness of the high pass filter 174 is a result of relative phase shift tracking of the amplifiers 188 and 202. This phase shift tracking occurs when the value of the resistor 190 and capacitor 192 is equal to the value of the resistor 194 and capacitor 198. The values of this resistor and capacitor combination are selected for a crossover frequency near 3 KHz and shown as waveform B in FIG. 9. Under this condition, the output of the amplifier 188 and the amplifier 202 over a range of frequencies from below 60 Hz to well above 60 Hz will track in relative phase shift and amplitude.

At a frequency well above 60 Hz, the amplitude of the filter 174 will begin to roll off, but the relative phase will continue to track. A high common mode rejection of the differential amplifier 210, which is adjustable by adjustable resistor 208, exhibits very good rejection of the 60 Hz frequencies. However, as waveform B in FIG. 9 illustrates, the high frequency components of the pulses are passed. The resistor 176 develops the signal voltage from the clamp 16 and the amplifier 178 insures a good equal low impedance source for the amplifier 202 and the amplifier 188.

While the invention has been particularly shown, described and illustrated in detail with reference to the preferred embodiments and modifications thereof, it should be understood by those skilled in the art that equivalent changes in form and detail may be made therein without departing from the true spirit and scope of the invention as claimed except as precluded by the prior art.

The embodiments of the invention for which as exclusive privilege and property right is claimed are defined as follows:

1. The power line cable selector system for indicating to a lineman which buried cable has been de-energized when compared to other energized buried cables carrying a typical 60 Hz power line current, the selector system designed to be connected to a first and a second end of the de-energized cable, connected to a first and a second ground line at the first and second ends of the de-energized cable and for engaging a portion of the cable at a midspan location between the first and second ends, the selector system comprising:
a low power pulse generator adapted for connecting to the first end of the de-energized cable and to the first ground line and delivering a low voltage test signal through the de-energized cable;
a jumper cable adapted for connecting to the second end of the de-energized cable and to the second ground line; and
a portable hand-held pulse receiving receiver and cable detector unit adapted for engaging a cable at the midspan location and indicating to the lineman if the test signal is received and if the cable being tested is the de-energized cable.

2. The selector system as described in claim 1 wherein said low power pulse generator is a battery powered low power pulse generator.

3. The selector system as described in claim 1 wherein said generator is adapted for connecting to a first end of the de-energized cable's insulated conductor and adapted for connecting to the first ground line, the first ground line is connected to common neutrals of the de-energized cable and common neutrals of the other energized cables.

4. The selector system as described in claim 1 wherein said jumper cable is connected to a second end of an insulated conductor of the de-energized cable and the second ground line is connected to common neutrals of the de-energized cable and common neutrals of the other energized cables.

5. The selector system as described in claim 1 wherein said pulse receiving receiver is a signal pick up clamp adapted for receipt around a portion of the cable at the midspan location.

6. The selector system as described in claim 1 wherein said cable detector unit includes an electronic parametric filter connected to a pulse amplifier, said pulse amplifier is connected to a monstable multivibrator, said multivibrator including an audio indicator and visual indicators.

7. The selector system as described in claim 6 wherein said audio indicator includes a horn and said visual indicators include a blinking LED and a current analog meter.

8. The selector system as described in claim 1 wherein said cable detector unit includes an electronic high pass filter connected to a pulse amplifier, said pulse amplifier is connected to a monstable multivibrator, said multivibrator including an audio indicator and visual indicators.

9. The selector system as described in claim 8 wherein said audio indicator includes a horn and said visual indicators include a blinking LED and a current analog meter.

10. The power line cable selector system for indicating to a lineman which buried cable has been de-energized when compared to other energized buried cables carrying a typical 60 Hz power line current, the selector system designed to be connected to a first and a second end of the de-energized cable, connected to a first and a second ground line at the first and second ends of the de-energized cable and for engaging a portion of the cable at a midspan location between the first and second ends, the selector system comprising:
a battery operated low power 1 Hz pulse generator, said generator adapted for connecting to the first end of the de-energized cable at an upstream disconnect station, said generator adapted for connecting to one end of the cable's insulated conductor and adapted for connecting to a first ground line, said generator designed to deliver a dc current spike and excite the otherwise de-energized conductor at one second intervals;
a jumper cable adapted for connecting to the second end of the de-energized cable at a downstream disconnect station, said jumper cable connected to the second ground line; and
a portable hand-held pulse receiving receiver and cable detector unit adapted for engaging a cable at the midspan location on the cable and indicating to the lineman if the test signal is received and if the cable being tested is the de-energized cable.

11. The selector system as described in claim 10 wherein said pulse receiving receiver is a signal pick up clamp adapted for receipt around a portion of the cable at the midspan location.

12. The selector system as described in claim 10 wherein said cable detector unit includes an electronic current parametric filter connected to a pulse amplifier, said pulse amplifier is connected to a monstable multivibrator, said monstable multivibrator including an audio indicator and visual indicators.

13. The selector system as described in claim 12 wherein said audio indicator includes a horn and said visual indicators include a blinking LED and a current analog meter.

14. The selector system as described in claim 10 wherein said cable detector unit includes a high pass filter connected to a pulse amplifier, said pulse amplifier is connected to a monstable multivibrator, said multivibrator including an audio indicator and visual indicators.

15. The selector system as described in claim 14 wherein said audio indicator includes a horn and said visual indicators include a blinking LED and a current analog meter.

16. The power line cable selector system for indicating to a lineman which buried cable has been de-energized when compared to other energized buried cables carrying a typical 60 Hz power line current, the selector system designed to be connected to a first and a second end of the de-energized cable, connected to a first and a second ground line at the first and second ends of the de-energized cable and for engaging a portion of the cable at a midspan location between the first and second ends, the selector system comprising:
a battery operated low power 1 Hz pulse generator, said generator adapted for connecting to the first end of the de-energized cable at an upstream disconnect station, said generator adapted for connecting to one end of the cable's insulated conductor and adapted for connecting to a first ground line, said generator designed to deliver a dc current spike and excite the otherwise de-energized conductor at one second intervals;
a jumper cable adapted for connecting to the second end of the de-energized cable at a downstream disconnect station, said jumper cable connected to the second ground line;
a signal pick up clamp adapted for receipt around a portion of the cable at the midspan location; and
a filter connected to said pick up clamp and to a pulse amplifier, said pulse amplifier connected to a monstable multivibrator.

17. The selector system as described in claim 16 wherein said cable detector unit includes a high pass filter connected to a pulse amplifier, said pulse amplifier is connected to a monstable multivibrator, said multivibrator including an audio indicator and visual indicators.

18. The selector system as described in claim 17 wherein said audio indicator includes a horn and said visual indicators include a blinking LED and a current analog meter.

19. The selector system as described in claim 16 wherein said cable detector unit includes an electronic current parametric filter connected to a pulse amplifier, said pulse amplifier
is connected to a monstable multivibrator, said monstable multivibrator including an audio indicator and visual indicators.

20. The selector system as described in claim 19 wherein said audio indicator includes a horn and said visual indicators include a blinking LED and a current analog meter.
